(19) United States
(12) Patent Application Publication
(10) Pub. No.: US 2004/0080153 A1
(43) Pub. Date: Apr. 29, 2004

(54) Greeting card

(76) Inventor: Gregory McCreath, Honeydew (ZA)

Correspondence Address: DOWELL & DOWELL PC, SUITE 309, 1215 JEFFERSON DAVIS HIGHWAY, ARLINGTON, VA, 22202

(21) Appl. No.: 10/451,802

(22) PCT Filed: Dec. 27, 2001
(86) PCT No.: PCT/IB01/02677

(30) Foreign Application Priority Data
Dec. 27, 2000 (ZA) 2000-4852

(51) Int. Cl. B42D 15/00

(52) U.S. Cl. 283/61

(57) ABSTRACT

A greeting card comprises a telephone number and a receiving zone for receiving an Identification code. In use, the sender of the card dials the telephone number and is prompted to leave a voice message for the addressee of the card. Once the message has been recorded, the sender is provided with an identification code, which is entered in the receiving zone. The message and associated identification code are stored in a central database. Once the addressee receives the card, he or she needs to dial the telephone number indicated on the card to retrieve the sender's message. Upon dialing the indicated telephone number, the addressee will be prompted to enter or provide the identification code. Once this is done, the pre-recorded message, which was left by the sender, is retrieved and played to the addressee.

### BACKGROUND OF THE INVENTION

THIS invention relates to a greeting card.

Conventional greeting cards allow the sender thereof to write a personal message on the card for the addressee. These types of greeting cards have remained substantially unchanged for a number of years and it would be desirable to have a greeting card which would allow the sender to send a message to the addressee in a novel way.

In addition, since the message is written on the card itself, there is always the possibility that someone other than the addressee could read the personal message. This results in the sender being hesitant to freely express his or her feelings on the card itself, and there is therefore a need for a greeting card which will allow the sender to send a personal message to the addressee knowing that no-one else will receive the message, or at least that the chances of someone else receiving the message are substantially reduced.

### SUMMARY OF THE INVENTION

According to a first aspect of the invention there is provided a greeting card carrying resource locating means for locating, via a telecommunications network, a remote message, the remote message typically being associated with and locatable by an addressee of the card.

The resource locating means preferably is a telephone number or an e-mail address.

Preferably, the message is a prerecorded personalised message which is conveniently recorded by a sender of the card, and is resident on a database, with the greeting card further including an identification code for identifying the message on the database.

According to a second aspect of the invention there is provided a method of sending a message, the method including the steps of:

providing a greeting card;

enabling a message for the addressee of the greeting card to be recorded, preferably at a central database; and

providing resource locating means on the greeting card for allowing the addressee to locate and retrieve the recorded message.

The method typically includes the step of providing an identification code for identifying and retrieving the message from the database.

According to a third aspect of the invention there is provided a system for sending a message, the system including:

a plurality of greeting cards;

a central database for receiving and recording a remote message, the remote message typically being associated with the addressee of the card; and

resource locating means for locating, via a telecommunications network, the remote message.

Typically, the resource locating means is a telephone number or an e-mail address.

Preferably, the system includes an identification code for locating the message on the central database.

### BRIEF DESCRIPTION OF THE DRAWINGS

FIG. 1 shows a rear view of a greeting card of the invention; and

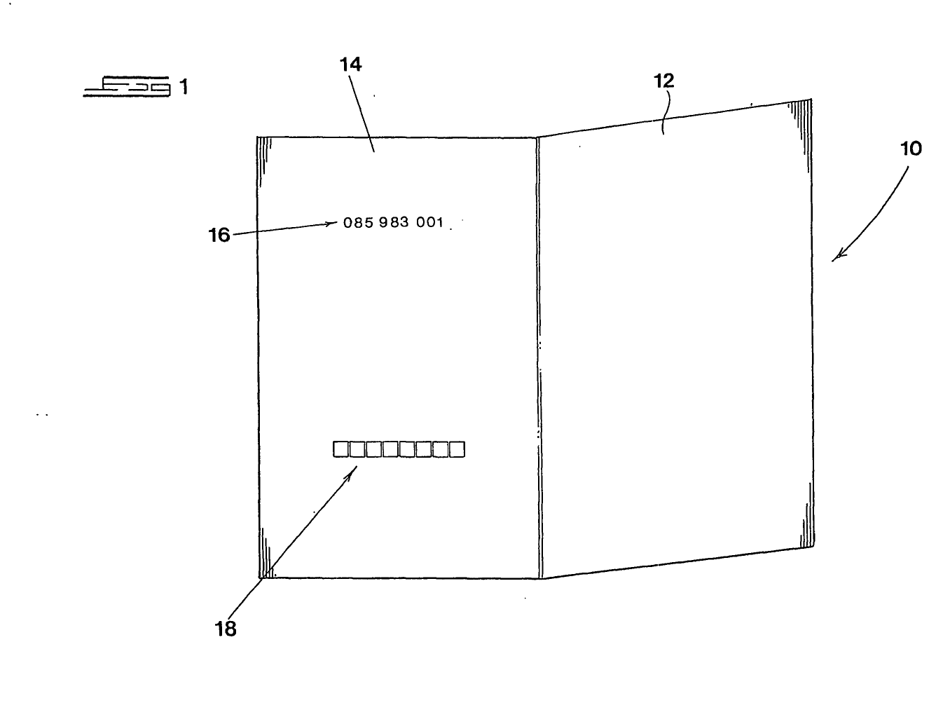

FIG. 2 shows a schematic block diagram of a system for sending a message via the greeting card of the invention.

### DESCRIPTION OF EMBODIMENTS

Referring to the figures, a greeting card 10 comprises a front flap portion 12 and a rear flap portion 14. The front flap portion 12, as with conventional greeting cards, is printed with a message, typically conveying good wishes. The rear flap portion 14 of the greeting card 10 carries a set of instructions explaining how the card 10 is to be used. Alternatively, the set of instructions may be in the form of a separate insert which is placed within the card 10. The set of instructions includes resource locating means in the form of a telephone number 16, and an empty receiving zone 18 for receiving an identification code.

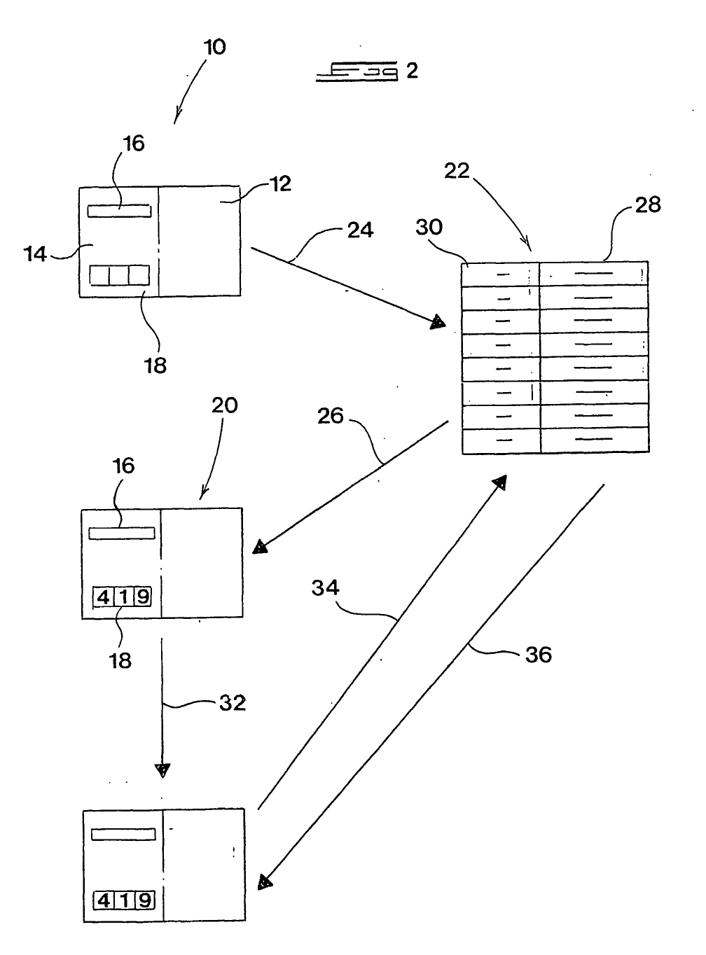

In use, the sender of the card 10 dials the telephone number 16 indicated on the card 10. The sender is then prompted to leave a voice message for the addressee of the card 10, as with a conventional telephone answering or voicemail system. Once the sender has recorded his or her message for the addressee, the sender is provided with an identification code, typically an 8-digit number, which is entered in the receiving zone 18, as shown at 20 in FIG. 2. Although the identification code shown in FIG. 2 takes the form of a 3-digit number, namely 419, it is envisaged that an 8-digit number will be used for the code.

The message and associated identification code are stored in a central database 22, with the transfer of the message from the sender to the database 22 being indicated by arrow 24, and the transfer of the identification code back to the sender being indicated by arrow 26. The database 22 includes a message database component 28, which stores the message(s) transferred by the sender(s), and an identification code database component 30, which stores the identification code(s) associated with the message(s). Clearly, each message stored on the database 22 has a unique identification code associated with it.

The card 10 is then mailed or delivered to the addressee in a conventional manner, as indicated by arrow 32. Once the addressee receives the card 10, he or she needs to dial the telephone number 16 indicated on the card to retrieve the sender's message. Upon dialing the indicated telephone number 16, the addressee will be prompted to enter or provide the identification code 18, as indicated by arrow 34. Once this is done, the pre-recorded message, which was left by the sender, is retrieved and played to the addressee, as indicated by arrow 36.

A significant advantage of the present invention is that the sender of the card can provide the addressee with a truly personal message in a relatively secure manner. In addition, since a set of instructions is printed on every card, the card is relatively simple to use by both the sender and the addressee.

1. A greeting card carrying resource locating means for locating, via a telecommunications network, a remote message, the remote message being associated with and locatable by an addressee of the card.

2. A greeting card according to claim 1 wherein the resource locating means is a telephone number or an e-mail address.

3. A greeting card according to either one of the preceding claims wherein the message is a pre-recorded personalised message which is recorded by a sender of the card, and is resident on a database.

4. A greeting card according to claim 3 wherein the greeting card further includes an identification code for identifying the message on the database.

5. A method of sending a message, the method including the steps of:
providing a greeting card;
enabling a message for the addressee of the greeting card to be recorded; and
providing resource locating means on the greeting card for allowing the addressee to locate and retrieve the recorded message.

6. A method of sending a message according to claim 5 wherein the message for the addressee of the greeting card resides on a database.

7. A method of sending a message according to claim 6 which includes the step of providing an identification code for identifying and retrieving the message from the database.

8. A system for sending a message, the system including:
a plurality of greeting cards;
a central database for receiving and recording a remote message, the remote message being associated with the addressee of the card; and
resource locating means for locating, via a telecommunications network, the remote message.

9. A system according to claim 8 wherein the resource locating means is a telephone number or an e-mail address.

10. A system according to either one of the preceding claims 8 or 9 which includes an identification code for locating the message on the central database.
